(19) United States
(12) Patent Application Publication
(10) Pub. No.: US 2015/0127974 A1
(43) Pub. Date: May 7, 2015

(54) METHOD OF STORING A DATA ITEM IN A DISTRIBUTED DATA STORAGE SYSTEM, CORRESPONDING STORAGE DEVICE FAILURE REPAIR METHOD AND CORRESPONDING DEVICES

(71) Applicant: THOMSON LICENSING, Issy de Moulineaux (FR)

(72) Inventors: Steve Jiekak, Romanel-sur-Lausanne (CH); Nicolas Le Scouarnec, Liffre (FR)

(73) Assignee: THOMSON LICENSING, Issy de Moulineaux (FR)

(21) Appl. No.: 14/398,594

(22) PCT Filed: Apr. 24, 2013
(86) PCT No.: PCT/EP2013/058435

§ 371 Date: Nov. 3, 2014

(30) Foreign Application Priority Data
May 4, 2012 (EP) 12166826.3

(51) Int. Cl. G06F 11/10

(52) U.S. Cl. CPC G06F 11/1092
USPC 714/6.24

(57) ABSTRACT

The methods of the invention of storing a data item and the associated method of repair of a failed storage device allow exact repair of the data lost by a failed storage device in a distributed data storage system. As repaired data is exactly identical to lost data, this simplifies data integrity checking, which is appealing for distributed data storage systems that require a high level of data security. The methods and devices of the invention use erasure correcting codes that are optimized at the MBCR point such that they minimize both storage size required to store a data item and repair bandwidth required for data- and message exchange between the devices of the distributed storage system in case of repair.

### 1. FIELD OF INVENTION

The present invention relates to the field of distributed data storage, and in particular, to storing data in a distributed data storage system and exact repair of failed storage devices.

### 2. TECHNICAL BACKGROUND

The quantity of digital information that is stored by digital storage systems, be it data, photos or videos, is ever increasing. Today, a multitude of digital devices are interconnected via networks such as the Internet, and distributed systems for data storage, such as P2P (Peer-to-Peer) networks and cloud data storage services, have become an interesting alternative to centralized data storage. Even common user devices, such as home PC's or home access gateways can be used as storage devices in a distributed data storage system. However, one of the most important problems that arise when using a distributed data storage system is its reliability. In a distributed data storage system where storage devices are interconnected via an unreliable network such as the Internet, connections to data storage devices can be temporarily or permanently lost, for many different reasons, such as device disconnection due to a voluntary powering off or involuntary power surge, entry into standby mode due to prolonged inactivity, connection failure, access right denial, or even hardware failure. Solutions must therefore be found for large-scale deployment of fast and reliable distributed storage systems. According to prior art, the data to store are protected by devices and methods adding redundant data. According to prior art, this redundant data are either created by mere data replication, through storage of simple data copies, or, for increased storage quantity efficiency, in the form of storing the original data in a form that adds redundancy, for example through application of Reed-Solomon (RS) codes or other types of erasure correcting codes. For protecting the distributed data storage against irremediable data loss it is then essential that the quantity of redundant data that exists in a distributed data storage system remains at all times sufficient to cope with an expected loss rate, i.e. the expected frequency of failure of storage devices in the distributed data storage system. As storage device failures occur, some redundancy disappears. The distributed data storage system is self-healing, in that if a certain quantity of redundant data is lost, it is regenerated in due time to ensure this redundancy sufficiency. In a first phase, the self-healing mechanism monitors the distributed data storage system with regard to the occurrence of storage device failures. In a second phase, the distributed data storage system triggers regeneration of lost redundancy data on a set of spare storage devices. The lost redundancy is regenerated from the remaining redundancy. However, when redundant data is based on erasure correcting codes, regeneration of the redundant data is known as inducing a high repair cost, i.e. resulting in a large communication overhead. This is because it requires downloading and decoding (application of a set of computational operations) of a whole item of information, such as a file, in order to be able to regenerate the lost redundancy. This high repair cost can however be reduced significantly when redundant data is based on so-called regenerating codes, issued from network information theory; regenerating codes allow regeneration of lost redundancy without decoding.

Lower bounds (tradeoffs between storage and repair cost) on repair costs have been established both for the single failure case and for the multiple failures case. The two extreme points of the tradeoff are Minimum Bandwidth (MBR, also referred to as MBCR), which minimizes repair cost first, and Minimum Storage (MSR, also referred to as MSCR), which minimize storage first. Codes matching these theoretical tradeoffs can be built using non-deterministic schemes such as random linear network codes.

However, non-deterministic schemes for regenerating codes have the following drawbacks: they (i) require homomorphic hash function to provide basic security (integrity checking), (ii) cannot be turned into systematic codes, i.e. offering access to data without decoding (i.e. without additional computational operations), and (iii) provide only probabilistic guarantees of repair. Deterministic schemes are interesting if they offer both systematic form (i.e., the data can be accessed without decoding) and exact repair (during a repair, the block regenerated is equal to the lost block, and not only equivalent). Exact repair is a more constraining problem than non-deterministic repair which means that the existence of non-deterministic schemes does not imply the existence of schemes with exact repair.

For the single failure case, code constructions with exact repair have been given for both the MSR point and the MBR point. However, the existence of codes supporting the exact repair of multiple failures, referred to hereinafter as exact coordinated/adaptive regenerating codes, is still an open question. Prior art concerns the case of single failures and a restricted case of multiple failure repairs, where the data is split into several independent codes and each code is repaired independently, using a classical repair method for erasure correcting codes. This case is known as d=k, d being the number of storage devices contacted during repair and k being the number of storage devices contacted when decoding. The latter method does not reduce the cost in terms of number of bits transferred over the network for the repair operation when compared to classical erasure correcting codes.

Thus, solutions for regeneration of redundant data in distributed storage systems that are based on exact regenerating codes can still be optimized with regard to the exact repair of multiple failures. This is interesting for application in distributed data storage systems that require a high level of data storage reliability while keeping the repair cost as low as possible.

### 3. SUMMARY OF THE INVENTION

In order to propose an optimized solution to the problem of how to repair multiple failures in a distributed storage system using exact regenerating codes, the invention proposes a method and device for adding lost redundant data in a distributed data storage system through coordinated regeneration of codes different than the previously discussed regenerating codes, because of the exact repair of lost data.

When evaluating distributed storage systems, two parameters are of particular importance, namely “network repair cost” and “storage cost”. Network repair cost is expressed in amount of data transmitted during a repair over the network interconnecting the distributed storage devices. Storage cost is expressed in amount of data stored in the distributed data storage system to offer a desired data protection.

The mentioned optimization procured by the method of the invention, that uses MBCR codes, reduces, when compared to methods based on RS codes, the network repair cost. Using the method of the invention, the storage cost is kept low but slightly higher than with RS codes. The storage cost is reduced when the method of the invention is compared to a distributed data storage system that uses pure replication however.

When the method of the invention is compared to functional regenerating codes, i.e. non-deterministic regenerating codes, the method of the invention is optimized with regard to offering increased security that lost data is repairable, the method of the invention being a method of exact repair, and reduced computational cost, the repair needing less computational resources.

Compared to regenerating codes supporting a single failure, the method of the invention is optimized with regard of the I/O required to repair due to the fact that multiple repairs are performed at once, and storage devices providing data to storage devices being repaired will be solicited only once for several repairs instead of once for each individual repair.

Overall, our method offers an improved tradeoff between the constraints imposed by known distributed data storage systems.

The mentioned advantages and other advantages not mentioned here, that make the device and method of the invention advantageously well suited for storing a data item in a distributed data storage system and for storage device failure repair, will become clear through the detailed description of the invention that follows.

In order to provide an optimized method of storing data in a distributed data storage system, the invention comprises a method for storing a data item in a distributed data storage system comprising n storage devices and supporting up to r storage device failures and in which d storage devices are available for repair of t=n-d failed storage devices, the method comprising the following steps:
I. splitting (501) the data item in M=k*n+k*[d−k] data blocks where k=n−r;
II. storing (502) k*n of the M data blocks on the n storage devices so that each of the n storage devices store k different of the k*n data blocks;
III. for the remaining k*[d−k] of the M data blocks consisting of d−k groups of k data blocks, execution, for each group, of a first operation (503) of encoding using a Maximum Distance Separable coding scheme to produce n different encoded data blocks and storing the n different encoded data blocks on the n storage devices so that each of the n storage devices stores a different encoded data block and repeating (504) this first operation for all of the d−k groups of the remaining data blocks;
the data blocks stored in steps II and III being primary data blocks of the data item, spread over n storage devices of the distributed storage system, so that each of the n storage devices stores k blocks from step II and d−k blocks from step III;
IV. for each of the n storage devices, executing a second operation (505) of encoding, using a Maximum Distance Separable coding scheme, the k primary data blocks and the d−k primary data blocks stored by that storage device in steps II and m to produce a secondary data block, and repeating (506) this second operation n−1 times to produce and store n−1 different secondary data blocks, where the n−1 different secondary data blocks are spread over the n−1 other storage devices such that each of the n−1 other storage devices stores a different secondary data block,
the n−1 different secondary data blocks stored in step IV being secondary data blocks that offer a protection of the primary data blocks stored by each of the n storage devices which is spread over the n−1 other storage devices.

According to a variant embodiment of the invention, the M data blocks result from a data preprocessing.

According to a variant embodiment of the invention, the Maximum Distance Separable coding schemes used in the first operation are identical in each repetition of the first operation.

According to a variant embodiment of the invention, the Maximum Distance Separable coding schemes used in the first operation are different in each repetition of the first operation.

According to a variant embodiment of the invention, the Maximum Distance Separable coding schemes used in the second operation are identical in each repetition of the second operation.

According to a variant embodiment of the invention, the Maximum Distance Separable coding schemes used in the second operation are different in each repetition of the second operation.

The invention also comprises an associated method for repairing of t failed storage devices in a distributed data storage system according to the invention, that comprising n storage devices and supporting up to r storage device failures and where d storage devices are available to provide data for repair, the method using primary blocks being the data blocks stored in steps II and III of the method of storing of the invention, and the method using secondary blocks being the n−1 different secondary data blocks stored in step IV of the method of storing according to the invention, the method comprising the following steps:
I. In a data collecting step, each of t replacement storage devices fetches one secondary data block from each of the d storage devices available to provide data for repair and decodes d blocks thus obtained, to recover d primary data blocks;
II. In an encoding step,
   a) all t replacement storage devices encode the d primary blocks they recovered to produce a resulting secondary data block which is sent to each of the other t−1 replacement storage devices;
   b) all d storage devices that are available to provide data for repair encode the d primary blocks they detain to produce t different resulting secondary data blocks which are sent to the t replacement storage devices, each of t replacement storage devices receiving one of the t different resulting secondary data blocks from a same of the d storage devices;
III. In a storage step, all t replacement storage devices store the secondary data blocks they received in the previous steps.

The invention also comprises a replacement storage device part of t replacement storage devices for exact repair of t failed storage devices interconnected in a distributed storage system, the replacement device being characterized in that it comprises the following means:
means for collecting data (713), where the replacement storage device fetches one secondary data block from each of d storage devices available to provide data for repair;
means for decoding (711) d blocks thus obtained, to recover d primary data blocks;
means for encoding (711) the d primary data blocks recovered to produce a resulting secondary data block and means (713) to transmit this resulting secondary data block to each of the other t−1 replacement storage devices;
means for receiving (715) of resulting secondary data blocks that are transmitted by the d storage devices available for repair and by the t−1 other replacement devices;
means for storing (702) of the primary data blocks recovered and the secondary data blocks received.

### 4. LIST OF FIGURES

More advantages of the invention will appear through the description of particular, non-restricting embodiments of the invention. The embodiments will be described with reference to the following figures:

FIG. 1 shows a typical prior-art use of erasure correcting codes to provide error resilience in distributed storage systems.

FIG. 2 further illustrates the background of the invention.

FIGS. 3a-b illustrate the method of storing a data item according to the invention according to a particular and non-limiting embodiment.

FIGS. 4a-b illustrate a different and non-limiting way of determining which storage devices are comprised in the first and the second set of non-failed storage devices.

FIG. 5 illustrates the method for storing a data item according to a particular non-limiting embodiment of the invention in flow chart form.

FIG. 6 illustrates the method for repairing failed storage devices according to according to a particular and non-limiting embodiment of the invention in flow chart form.

FIG. 7 shows non-limiting example of a storage device that can be used as a storage device in a distributed storage system that is suited for implementing the method of the invention and its different, non-limiting variants.

FIG. 8 shows a non-limiting alternative example of a storage device that can be used as a storage device in a distributed storage system that implements the method of the invention and its different, non-limiting variants.

### 5. DETAILED DESCRIPTION OF THE INVENTION

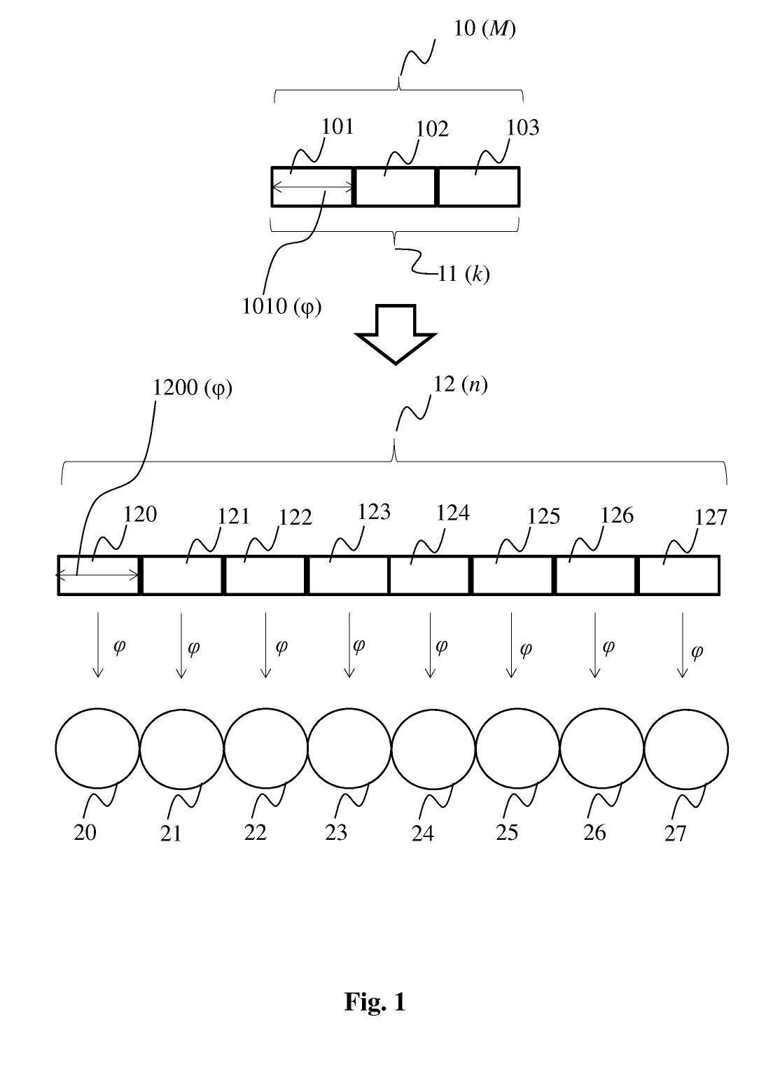

FIG. 1 shows a typical prior-art use of erasure correcting codes to provide error resilience in distributed storage systems. These erasure correcting codes are for example implemented using well-known Reed-Solomon coding (RS), often referred to as RS(n,k), where n is the number of encoded data blocks, and k is the number of blocks of the original data item. An example RS(8,3) data encoding is illustrated for a file 10 of quantity M data blocks each of size φ. First, the data item is divided into M=k=3 blocks of quantity φ, the quantity being illustrated by arrow 1010. After application of an RS(8,3) encoding algorithm 11, the original data is transformed in n=8 different encoded data blocks of the same quantity of each of the original k data blocks, i.e. of quantity φ, the quantity being illustrated by arrow 1200. It is this RS(8,3) encoded data that is stored in the distributed data storage system, represented in the figure by circles 20 to 27 which represent storage devices or devices of a distributed data system. Each of the different encoded blocks of quantity α is being stored on a different storage device. There is no need to store the original data item 101-103, knowing that the original data item can be recreated from any k out of n different encoded blocks. The number n=8 of different encoded data blocks is for example chosen as a function of the maximum number of simultaneous device failures that can be expected in the distributed data storage system, in our example n−k=5.

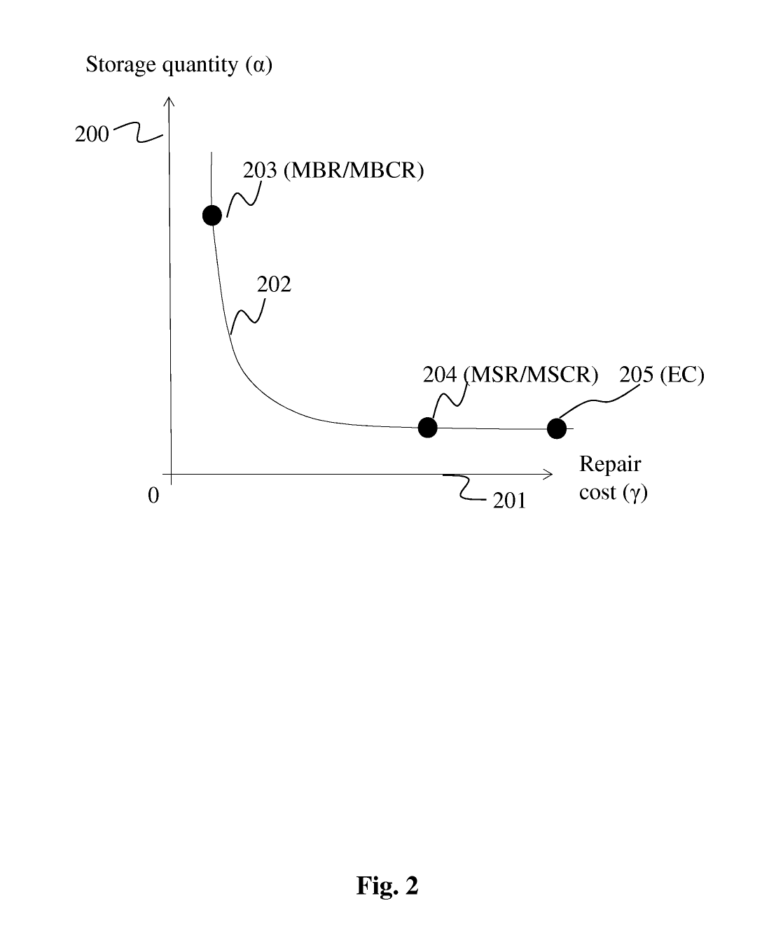

FIG. 2 further illustrates the background of the invention. Known regenerating codes MBR (Minimum Bandwidth Regenerating) 203 and MSR (Minimum Storage Regenerating) 204 offer improved performances in terms of network bandwidth used for repair when compared to classical erasure correcting codes 205.

We consider an n devices system storing a data item i of M data blocks. The data item is encoded and distributed over all n devices, each of these storing α data blocks, in such a manner that any of k devices allow recovering the data item i. Whenever the devices fail, they must be repaired to avoid that the level of redundancy drops below a critical level where a complete repair is no longer possible. Repairing with classical erasure correcting codes implies downloading and decoding the whole data item before encoding again. As can be seen at point 205 in FIG. 2, this implies huge repair costs in terms of network communications. These costs can be significantly reduced when using regenerating codes, of which the points MBR 203 and MSR 204 are shown. MBR 203 represents optimal performance in terms of minimal quantities of data exchanged between storage devices for the repair, and MSR 204 representing optimal performance in terms of storage needed by the storage devices to ensure a possible repair. Repair cost in terms of data exchanged over the network γ is depicted on the x-axis, whereas storage quantity α is represented on the y-axis. With regenerating codes, in order to repair, the failed device contacts d>k non-failed devices and gets β data blocks from each, β<α. Regenerating codes have been extended to the handling of cases allowing to repair simultaneously t failed storage devices. In this case the devices that replace the t failed devices coordinate and exchange β′ data blocks. The data is then processed and α data blocks are stored. The two extreme points MSR, named MSCR when multiple repairs are considered, and MBR, named MBCR when multiples repairs are considered, are the most interesting optimal tradeoff points. Non-deterministic coding schemes matching these tradeoffs can be built using random linear network codes. The corresponding non-deterministic repairs are termed as functional repairs. However, by replacing Reed-Solomon codes with non-deterministic regenerating codes, the exact repair property is lost. The invention proposes the use of deterministic regenerating codes that do not lose the exact property that was available with Reed-Solomon codes, while still allowing to significantly optimizing the use of resources in the distributed storage system as with non-deterministic regenerating codes. This is important because non-deterministic codes, which do not support exact repair, have several disadvantages. They have high decoding costs. They make the implementation of integrity checking complex by requiring the use of homomorphic hashes, which are specific hashes such that the hash of a linear combination of blocks can be computed from the hashes of these individual blocks. They cannot be turned into systematic codes, which provide access to data without decoding. Finally, they can only provide probabilistic guarantees for repair.

The current invention therefore concerns deterministic schemes where a lost data block is regenerated as an exact copy instead of being only functionally equivalent. The current invention concerns a code construction for scalar MBCR codes (an MBCR code is scalar when the data item is divided into exactly M=k*(2d−k+t) indivisible data blocks, contrary to vector codes, where the data item is divided into M=k*(2d−k+t)*C sub-blocks with C being an integer constant greater than 1) supporting exact repair for d>k, and t=n−d (d=the number of contacted non-failed storage devices for the repair; k=number of blocks in which the data item i is split; t=number of failed devices repaired simultaneously, n the total number of devices for supporting up to r=n-k failures).

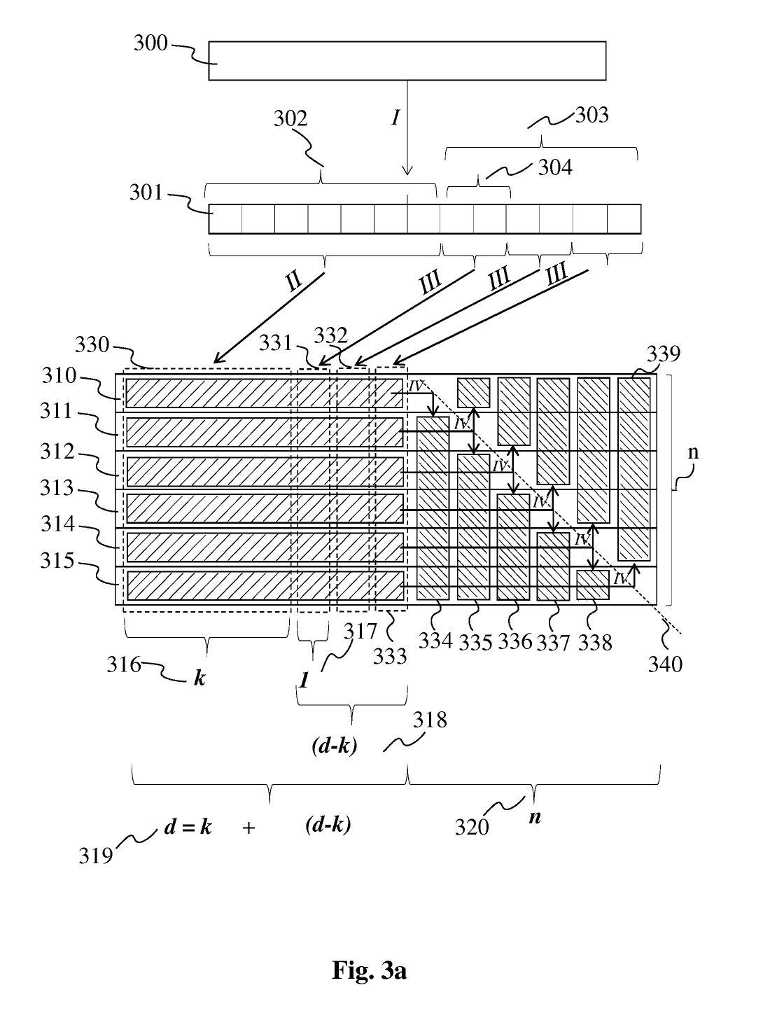

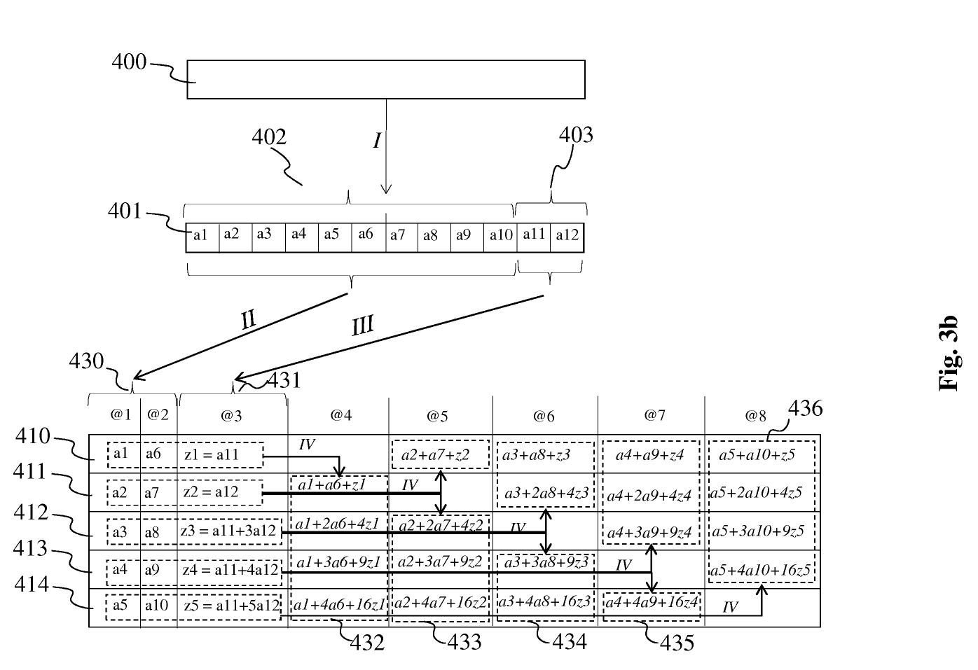

FIGS. 3a-b illustrate the method of storing a data item according to a particular, non-limited embodiment of the invention. In particular, FIG. 3a shows the general overview of the storing method according to the invention, and FIG. 3b shows a concrete example of a particular, non-limited embodiment of the storing method for an example case of n=5, k=2, d=3, t=2. According to the definitions used in the notation system of the illustrations, n is the number of storage devices in the distributed storage system implementing the method of storing a data item 300, k is the minimal number of storage devices needed for recovering of the original data from data item 300, d is the number of storage devices from which data is retrieved during repair, and t is the number of storage devices that are repaired simultaneously in a coordinated way according to the repair method of the invention.

In FIG. 3a, reference numbers 310-315 represent n storage devices and memory zones used for storage of the data item and its redundancy data. Rectangles 330-339 represent a grouping of memory zones that span over the different storage devices. Roman numbers I-IV represent steps in the method of storing.

In a first step I, data item 300 is split into M=k*n+k*(d−k) data blocks (illustrated by reference numbers 300, being the original data item, 301, being the original data item split into data blocks, 302, representing k*n of the M data blocks, 304 representing d−k of the M data blocks, and 303, representing k*(d−k) of the M data blocks.

In a second step II of storage of ‘primary’ data blocks, k*n of the M data blocks are stored on the n storage devices 310-315 in memory zone 330 so that each of the n storage devices store k different of the k*n data blocks.

In a third step III of storage of ‘primary’ data blocks, the remaining k*(d−k) (303) of the M data blocks, that consist of d−k groups of k data blocks, are encoded for each group using a first operation of Maximum Distance Separable (MDS) coding scheme. The MDS coding scheme is for example a RS encoding (Reed-Solomon), where k original data blocks are transformed into n encoded data blocks, such that any k out of the n encoded data blocks can be used to recover the k original data blocks. This a technique well-known from prior art coding theory, which is used as a ‘black box’ in the method for storing according to the current invention. With the MDS coding scheme, each group of k (304) data blocks is encoded to n different encoded data blocks, which are then stored on the n storage devices in memory zones 331-333 so that each of the n storage devices stores a different encoded data block. This encoding and storing is repeated for all of the remaining data blocks (d−k times).

The ‘primary’ data blocks are referred to as such because they represent an immediate storage of the data blocks of data item, either in unencoded, or in encoded form.

In a fourth step IV, for each of the n storage devices, a second operation of MDS encoding is executed, where the k ‘primary’ data blocks 316 and the (d−k) ‘primary’ data blocks 318 stored in steps II and III are encoded into n−1 different secondary data blocks, and where the n−1 different ‘secondary’ data blocks are spread over the n−1 other storage devices such that each of the n−1 other storage devices stores a different ‘secondary’ data block.

The n−1 different secondary data blocks stored in step IV are referred to as ‘secondary’ data blocks that offer a protection of the ‘primary’ data blocks stored by each of the n storage devices which is spread over the n−1 other storage devices.

Each storage device n stores own ‘secondary’ data only on the other n−1 devices, because it is not useful to store data about itself in case of failure of the storage device. This is visible in the figure as an empty diagonal 340.

FIG. 3b shows a concrete example of a particular, non-limited embodiment of the storing method for an example case of n=5, k=2, d=3, t=2. In this figure, reference numbers 410-414 represent n=5 storage devices and memory zones used for storage of the data item and its redundancy data. @1-@8 represent storage locations of each individual storage device. Dotted rectangles 430-436 represent a grouping of memory zones that span over the different storage devices. Roman numbers I-IV represent steps in the method of storing.

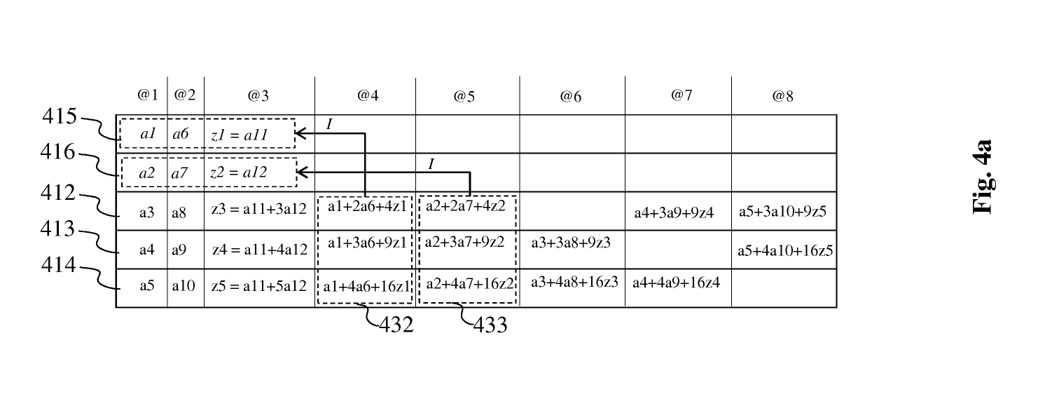

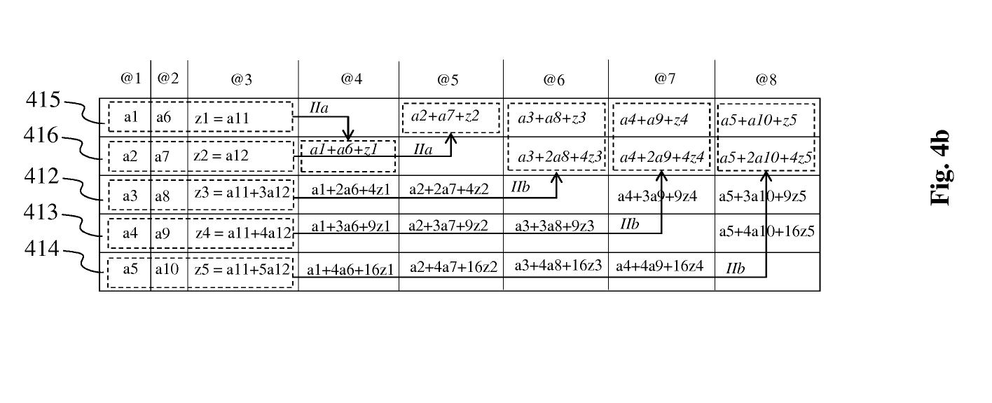

In a first step I, a data item 400 is split into M=k*n+k*(d−k) data blocks, i.e. 2*5+2*(3−2)=12 data blocks, that are numbered a1-a12. Original data blocks a11, a12 are transformed into z1-z5 using such a technique. A use of an MDS coding scheme used to recover lost data blocks appears in FIG. 4.

In a second step II, k*n=2*5=10 data blocks of the M=12 data blocks are stored on the n=5 storage devices such that each of the n=5 storage devices store k=2 different of the k*n=10 data blocks. I.e.:
data blocks a1, respectively a6 in storage location @1, respectively @2 of storage device 410;
data blocks a2, respectively a7 in storage location @1, respectively @2 of storage device 411;
data blocks a3, respectively a8 in storage location @1, respectively @2 of storage device 412;
data blocks a4, respectively a9 in storage location @1, respectively @2 of storage device 413;
data blocks a5, respectively a10 in storage location @1, respectively @2 of storage device 414.

In a third step III, for the remaining k*(d−k)=2*(3−2)=2 of the M=12 data blocks consisting of d-k=1 groups of k=2 data blocks, using an MDS coding scheme, a first operation is executed for each group of encoding the remaining 1 groups of 2 data blocks to produce n=5 different encoded data blocks and storing the n=5 different encoded data blocks on the n=5 storage devices so that each of the n=5 storage devices stores a different encoded data block and this first operation is repeated d-k=3−2=1 times. This results in
storing data block z1=a11 in storage location @3 of storage device 410;
storing data block z2=a12 in storage location @3 of storage device 411;
storing data block z3=a11+3a12 in storage location @3 of storage device 412;
storing data block z4=a11+4a12 in storage location @3 of storage device 413;
storing data block z5=a11+5a12 in storage location @3 of storage device 414.

Then, in a fourth step IV, for each of the n=5 storage devices, a second operation is executed wherein, using an MDS encoding scheme, the k=2 and the (d−k)=1 ‘primary’ data blocks (i.e. a total of 3 primary data blocks) that were stored by the storage device in steps II and III produce a ‘secondary’ data block. This second operation is repeated n−1=4 times to produce and store n−1=4 different ‘secondary’ data blocks. Finally, the n−1=4 different ‘secondary’ data blocks are spread over the n−1=4 other storage devices so that each of the n−1=4 other storage devices stores a different data block. This results in:
a1+a6+z1 being stored in memory location @4 of storage device 411;
a1+2a6+4z1 being stored in memory location @4 of storage device 412;
a1+3a6+9z1 being stored in memory location @4 of storage device 413;
a1+4a6+16z1 being stored in memory location @4 of storage device 414;
etc, as is shown in the figure for storage locations @5-@8 of storage devices 410-414.

The devices participating in the method of storing a data item according to the invention can be classified in management devices and storage devices. The management device being the device that writes the data to the storage system, the management device executes the steps that produce the primary data. The step (IV) for producing the secondary data is either executed by the management device or the storage devices.

This classification of the devices of the distributed data storage system can be ‘ad hoc’, i.e. just for the purpose of the storage of a data item, one device of the storage devices can take the role of a management device.

FIG. 4a-b illustrates the method of repair according to a particular, non-limited embodiment of the invention. In this example, storage devices 410 and 411 have failed and are repaired, introducing t=2 replacement storage devices 415 and 416. As for FIG. 3, the distributed data storage system comprises n=5 storage devices, and supports up to r=3 storage device failures, and d=3 storage devices are available to provide data for repair.

The method of repair is used to repair storage devices in a distributed storage system where a data item is stored according to the method of storing of the invention. The method uses the primary blocks being the data blocks stored in steps II and III of the method of storing of the invention, and said method using secondary blocks being the n−1 different secondary data blocks stored in step IV of the method of storing of the invention.

FIG. 4a-b represent the state of the memory of storage devices 412-416.

Referring to FIG. 4a, in a step I of data collecting, each of t=2 replacement storage devices (415, 416) fetches one secondary data block from each of the d=3 storage devices available to provide data for repair (412-414) and decodes d=3 blocks thus obtained, to recover d=3 primary data blocks (432, 433). The decoding consists of decoding the MDS codes of these three primary data blocks which allows to retrieve the values to store in the replacement devices: replacement storage device 415 stores a1 in memory location @1, and stores a6 in memory location @2, and stores all in memory location @3; and replacement storage device 416 stores a2 in memory location @1, stores a7 in memory location @2, and stores a12 in memory location @3.

In an encoding step IIa, all t=2 replacement devices encode the d primary data blocks (a1, a6 and z1 for device 415, and a2, a7 and z2 for device 416) to produce a resulting secondary data block (a1+a6+z1 is produced device 415, and a2+a7+z2 is produced by device 416) which is sent to each of the other t−1=2−1=1 replacement storage devices (a1+a6+z1 is sent to replacement storage device 416, and a2+a7+z2 is sent to replacement storage device 415). In an encoding step IIb, all d=3 storage devices that are able to provide data for repair (412,413,414) encode the d=3 primary data blocks they detain (a3, a8, z3 for 412; a4, a9, z4 for 413; and a5, a10 and z5 for 414) to produce t=2 different resulting secondary data blocks (a3+a8+z3 and a3+2a8+4z3 produced by 412; a4+a9+z4 and a4+2a9+4z4 produced by 413; and a5+a10+z5 and a5+2a10+4z5 produced by 414) which are sent to the t=2 replacement storage devices, each of t=2 replacement storage devices receiving one of the t=2 different resulting secondary data blocks from a same of the d=3 storage devices (415 receiving a3+a8+z3 from 412, a4+a9+z4 from 413 and a5+a10+z5 from 414; 416 receiving a3+2a8+4z3 from 412, a4+2a9+4z4 from 413, and A5+2a10+4z5 from 414).

In a storage step III, all t=2 replacement storage devices store the secondary data blocks they received in the previous steps.

As can be seen from comparing FIG. 4b with FIG. 3b, the replacement storage devices 415 and 416 now detain the same data blocks that were previously detained by failed devices 410 and 411.

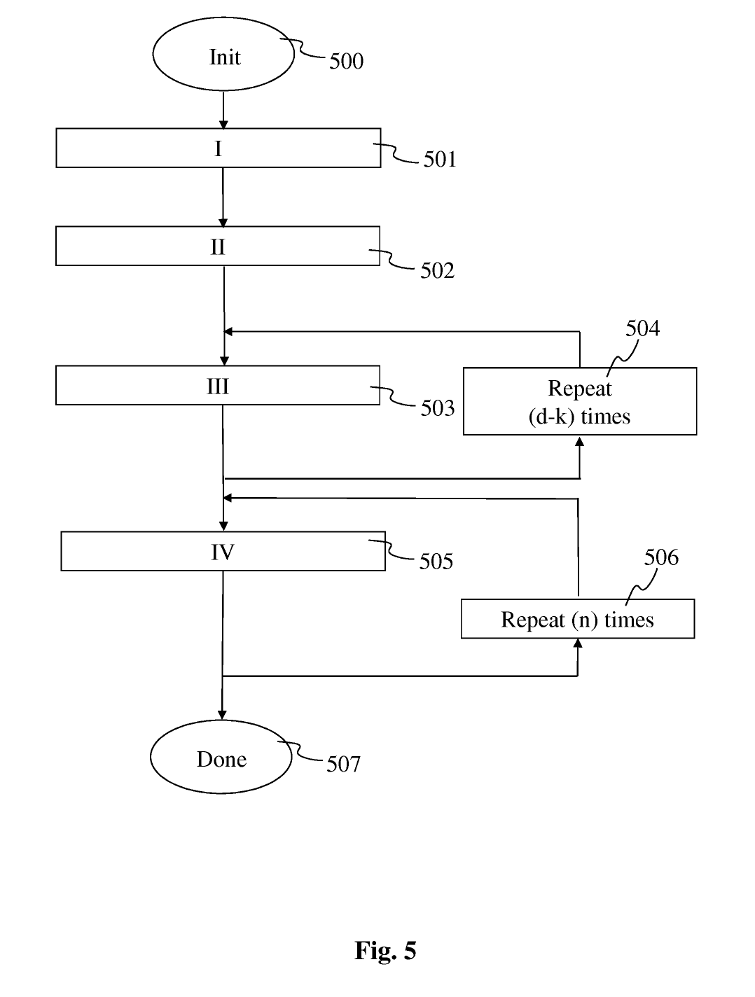

FIG. 5 illustrates the method of storing of a data item according to a particular, non-limited embodiment of the invention in flow chart form. In an initialization step 500, all memory zones of the device(s) executing the method of the invention that contain parameters that are needed for execution of the method are initialized. In a first step I (501), a data item is split into M=k*n+k*(d−k) data blocks. In a second step II (502) of storage of ‘primary’ data blocks, k*n of the M data blocks are stored on the n storage devices so that each of the n storage devices store k different of the k*n data blocks. In a third step III (503-504), of storage of ‘primary’ data blocks, each of the remaining d−k groups of k data blocks are encoded to d-k groups of n different encoded blocks using a first operation of Maximum Distance Separable (MDS) coding scheme (the MDS coding scheme used can be different for different groups), that are then spread on the n storage devices in memory zones 331-333 so that each of the n storage devices stores a different encoded data block from each group of n encoded data blocks. In a fourth step IV (505), for each of the n storage devices, a second operation of MDS encoding is executed, where the k ‘primary’ data blocks 316 and the (d−k) ‘primary’ data blocks stored in steps II and III produce a ‘secondary’ data block, and repeating this second operation n−1 times (506) to produce and store n−1 different ‘secondary’ data blocks, where the n−1 different ‘secondary’ data blocks are spread over the n−1 other storage devices such that each of the n−1 other storage devices stores a different ‘secondary’ data block. This step (505) is repeated for all of the n storage devices (506). In step 507, the storage according to the method is done, and can be repeated for another storage item.

The method may comprise an additional step of data preprocessing, such as permutation, pre-encoding (transformation by a MDS code like RS(k,k)) of the data blocks, or padding, e.g. adding some empty (null) bytes to obtain a integer number of data bytes in each data block, before executing steps I-IV of the method. Permutation/pre-encoding allows for example to obfuscate the data stored, which can be useful for reasons of data security protection. A preprocessing step can also be applied for spreading the data differently to offer an enhanced access pattern. Spreading the data differently can offer advantages of some data is accessed more frequently than others, or if some storage devices are less efficient than others.

It is not necessarily so that the MDS coding schemes in the first operation are all identical in each repetition of the first operation. They can be different for each iteration, or only for some iterations. The same is true for the MDS coding schemes used in the second operation. Using different coding schemes during the iterations of the first/second operations has the advantage of allowing the implementation of systematic MBCR codes (i.e., codes where the data can be read directly when the system is in a sane state).

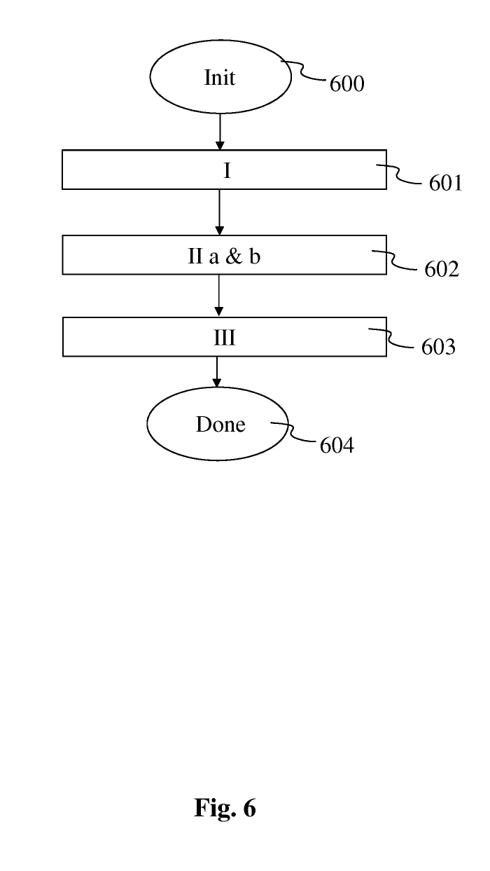

FIG. 6 shows the method of repairing a set of failed storage devices according to a particular, non-limited embodiment of the repair method of the invention in the form of a flow chart. In an initialization step (600), the method is initialized. This initialization comprises initialization of variables and memory space required for application of the method. In a step I of data collecting (601), each of t replacement storage devices fetches one secondary data block from each of the d storage devices available to provide data for repair and decodes d blocks thus obtained, to recover d primary data blocks.

In an encoding step Ha (602), all t replacement devices encode the d primary data blocks to produce a resulting secondary data block which is sent to each of the other t−1 replacement storage devices. In an encoding step IIb (602), all d storage devices that are able to provide data for repair encode the d primary data blocks they detain to produce t different resulting secondary data blocks which are sent to the t replacement storage devices, each of t replacement storage devices receiving one of the t different resulting secondary data blocks from a same of the d storage devices.

In a storage step III (603), all t replacement storage devices store the secondary data blocks they received in the previous steps.

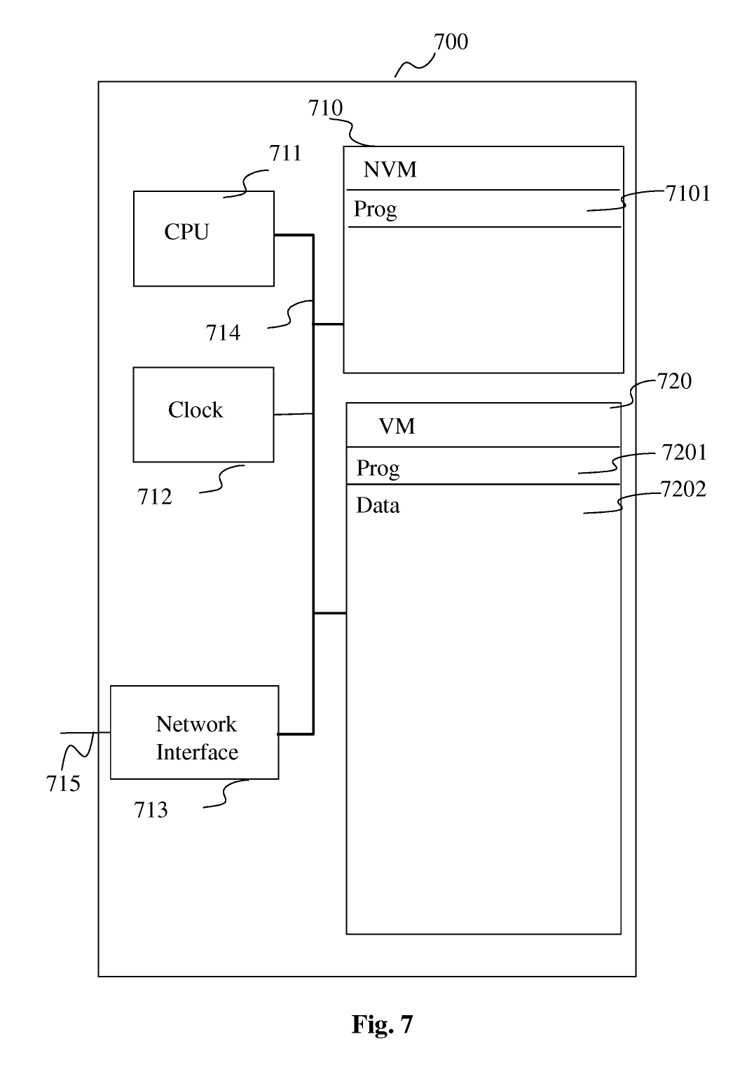

FIG. 7 shows a device that can be used as a storage device in a distributed storage system that implements the method of storing of a data item according to a particular, non-limited embodiment of the invention. The device 700 can be a general purpose device that either plays the role of a management device of a storage device. The device comprises the following components, interconnected by a digital data- and address bus 714:
a processing unit 711 (or CPU for Central Processing Unit);
a non-volatile memory NVM 710;
a volatile memory VM 720;
a clock 712, providing a reference clock signal for synchronization of operations between the components of the device 700 and for timing purposes;
a network interface 713, for interconnection of device 700 to other devices connected in a network via connection 715.

It is noted that the word “register” used in the description of memories 710 and 720 designates in each of the mentioned memories, a low-capacity memory zone capable of storing some binary data, as well as a high-capacity memory zone, capable of storing an executable program, or a whole data set.

Processing unit 711 can be implemented as a microprocessor, a custom chip, a dedicated (micro-) controller, and so on. Non-volatile memory NVM 710 can be implemented in any form of non-volatile memory, such as a hard disk, non-volatile random-access memory, EPROM (Erasable Programmable ROM), and so on.

The Non-volatile memory NVM 710 comprises notably a register 7201 that holds a program representing an executable program comprising the method of exact repair according to the invention. When powered up, the processing unit 711 loads the instructions comprised in NVM register 7101, copies them to VM register 7201, and executes them.

The VM memory 720 comprises notably:
a register 7201 comprising a copy of the program ‘prog’ of NVM register 7101;
a data storage 7202.

A device such as device 700 is suited for implementing the method of the invention of storing of a data item, the device comprising
means for splitting the data item in M=k*n+k*(d−k) data blocks (CPU 711, VM register 7202);
transmission means (713) for transmitting k*n of the M data blocks to the n storage devices such that each of the n storage devices receive and store k different of the k*n data blocks;
means for execution (CPU 711) of a first operation of encoding according to an MDS encoding scheme of the remaining k*(d−k) data blocks of the M data blocks to n different encoded data blocks and transmit and spread the n different encoded data blocks over the n storage devices so that each of the n storage devices stores a different encoded data block and repeating d−k times this first operation for all of the remaining data blocks;
means for execution (CPU 711) of a second operation of encoding according to an MDS encoding scheme of the k primary data blocks and the (d−k) data blocks stored on each of the n storage devices, to produce a secondary data block, this second operation being repeated n−1 times to produce and n−1 different secondary data blocks that are transmitted to and spread over the n−1 other storage devices so that each of the n−1 other storage devices stores a different secondary data block.

A device such as device 700 is also suited for implementing the method of repair and its different, non-limiting variants (e.g. as replacement storage device) and then comprises means for:
means for collecting data (network interface 713), where the device fetches one secondary data block from each of d storage devices available to provide data for repair,
means for decoding (CPU 711) d blocks thus obtained, to recover d primary data blocks;
means for encoding (CPU 711) d primary blocks recovered to produce a resulting secondary data block and means (713) to transmit this block to each of the other t−1 replacement storage devices;
means for receiving (Network interface 715) of resulting secondary data blocks that are transmitted by storage devices available for repair;
means for storing of the secondary data blocks received (VM 702).

A device such as device 700 is also suited for implementing the method of repair and its different, non-limiting variants (e.g. as a storage device available to provide data for repair of failed storage devices) and then comprises means for:
means for transmitting (network interface 713) a secondary data block to a replacement device;
means for encoding (CPU 711) the d data blocks it detains to produce t different resulting secondary data blocks; and
means for transmission (network interface 713) of the produced t different resulting secondary data blocks to the t replacement storage devices.

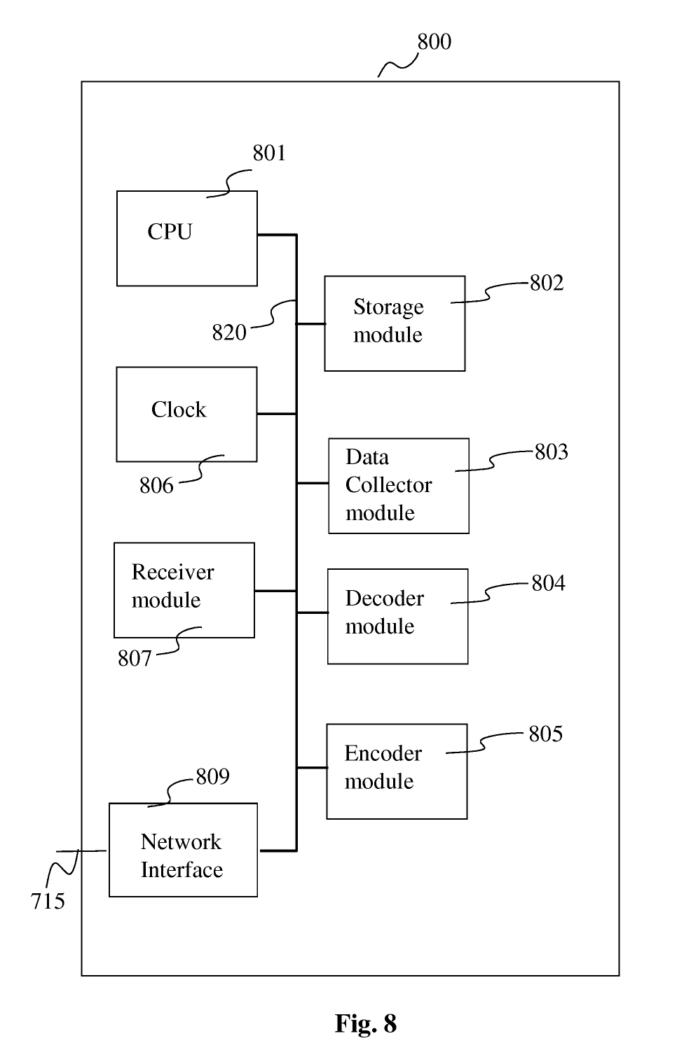

In a particular variant embodiment of a distributed data storage system according to the invention, management devices, storage devices and replacement devices are interchangeable, each being able to play the role of one of the other types of devices, making the distributed storage system thus flexible to cope with a need of either one or several of the cited device types. Non-limiting examples of devices that can implement the methods of the invention are given in FIGS. 7 and 8.

With regard to the method of storing a device playing the role of a management device may execute step I, II and III, whereas step IV is executed by each storage device, thereby realizing a form of load-balancing.

According to another variant implementation of the invention, all steps are performed by the management device, advantageously allowing storage devices to be simpler.

Other device architectures than illustrated by FIG. 7 are possible and compatible with the method of the invention. An example of such a non-limiting variant architecture is illustrated in FIG. 8. The device 800 comprises:
a Central Processing Unit or CPU 801, capable of executing program instructions stored in storage module 802;
a clock unit 806, that provides a reference clock signal for synchronization of operations between the components of the device 800 and for timing purposes;
a network interface 809, for interconnection of device 800 to other devices connected in a network via connection 715;
a data collector 803 for collecting data, where the replacement storage device fetches one secondary data block from each of d storage devices available to provide data for repair;
a decoder 804 for decoding d blocks thus obtained, and to recover d primary data blocks;
an encoder 805 for encoding the d primary data blocks recovered to produce a resulting secondary data block and the network interface to transmit this resulting secondary data block to each of the other t−1 replacement storage devices;
a receiver 807 for receiving of resulting secondary data blocks that are transmitted by the d storage devices available for repair and by the t−1 other replacement devices;
storage 802 for storing of the primary data blocks recovered and the secondary data blocks received.

According to variant embodiments, the invention is implemented as a pure hardware implementation, for example in the form of a dedicated component (for example in an ASIC, FPGA or VLSI, respectively meaning Application Specific Integrated Circuit, Field-Programmable Gate Array and Very Large Scale Integration), or in the form of multiple electronic components integrated in a device or in the form of a mix of hardware and software components, for example a dedicated electronic card in a personal computer.

The method according to the invention can be implemented according to the described, non-limiting different variant embodiments.

The method of repairing of the invention applies to repair of t failed storage devices. This t can take the value of 1, 2, 3, 10 or more. A threshold can be installed to trigger the repair per total number (x) of failed storage devices if the number of failed storage devices drops below a determined level. For example, instead of immediately repairing x failed storage devices when they have failed, it is possible to wait until a determined threshold superior to x storage devices fail, so that these repairs can, for example, be grouped and be programmed during a period of low activity, for example during nighttime. Of course, the distributed data storage system must then be dimensioned such that it has a data redundancy level that is high enough to support a failure of x storage devices.

According to a variant embodiment of the invention, a repair management server is used to manage the repair of storage device failures, in which case the steps of repairing are executed by the repair management server. Such a repair management server can for example monitor the number of storage device failures to trigger the repair of storage device pairs, with or without a previous mentioned threshold. According to yet another variant embodiment the management of the repair is distributed over the storage devices in the distributed data storage system, which has an advantage to distribute repair load over these devices and further renders the distributed data system less prone to management server failures (due to physical failure or due to targeted hacker attacks). In such a distributed variant embodiment, clouds can be created of storage devices that monitor themselves storage device failure for a particular data item, and that trigger autonomously a repair action when the storage device failure drops below a critical level. In such a distributed repair management, the steps of the method are implemented by several storage devices, the storage device communicating between them to synchronize the steps of the method and exchange data.

Besides being used for exact repair of failed storage devices, the method of repairing of the invention can also be used to add redundancy to a distributed storage system. For example as a preventive action when new measures of the number of observed device failures show that the number of device failures that can be expected is higher than previously estimated.

According to a variant embodiment of the invention, a storage device can store more than one encoded block of a particular file. In such a case, a device according to the invention can store more than one encoded blocks of a same file i, and/or can store encoded blocks of more than one file i.

1. A method for storing a data item in a distributed data storage system, wherein said distributed data storage system comprises n storage devices and supports up to r storage device failures and in which d storage devices are available for repair of t=n−d failed storage devices, said method comprising:
I. splitting the data item in M=k*n+k*[d−k] data blocks where k=n−r and d>k;
II. storing k*n of the M data blocks on the n storage devices so that each of the n storage devices store k different of the k*n data blocks;
III. for the remaining k*[d−k] of the M data blocks consisting of d−k groups of k data blocks, execution, for each group, of a first operation of encoding using a Maximum Distance Separable coding scheme to produce n different encoded data blocks and storing the n different encoded data blocks on the n storage devices so that each of the n storage devices stores a different encoded data block and repeating this first operation for all of the d−k groups of the remaining data blocks;
the data blocks stored in steps II and III being primary data blocks of said data item, spread over n storage devices of the distributed storage system, so that each of the n storage devices stores k blocks from step II and d−k blocks from step III;
IV. for each of the n storage devices, executing a second operation of encoding, using a Maximum Distance Separable coding scheme, the k primary data blocks and the d−k primary data blocks stored by that storage device in steps II and III to produce a secondary data block, and repeating this second operation n−1 times to produce and store n−1 different secondary data blocks, where the n−1 different secondary data blocks are spread over the n−1 other storage devices such that each of the n−1 other storage devices stores a different secondary data block,
the n−1 different secondary data blocks stored in step IV being secondary data blocks that offer a protection of the primary data blocks stored by each of the n storage devices which is spread over the n−1 other storage devices.

2. The method for storing a data item according to claim 1, wherein said M data blocks result from a data preprocessing.

3. The method for storing a data item according to claim 1, wherein the Maximum Distance Separable coding schemes used in said first operation are identical in each repetition of said first operation.

4. The method for storing a data item according to claim 1, wherein the Maximum Distance Separable coding schemes used in said first operation are different in each repetition of said first operation.

5. The method for storing a data item according to claim 1, wherein Maximum Distance Separable coding schemes used in said second operation are identical in each repetition of said second operation.

6. The method for storing a data item according to claim 1, where the Maximum Distance Separable coding schemes used in said second operation are different in each repetition of said second operation.

7. A method for repairing of t failed storage devices in a distributed data storage system, wherein said distributed data storage system comprises n storage devices and supports up to r storage device failures and where d storage devices are available to provide data for repair, said method using primary blocks being the data blocks stored in steps II and III of the method of storing according to claim 1, and said method using secondary blocks being the n−1 different secondary data blocks stored in step IV of the method of storing according to claim 1, said method comprising:
I. In a data collecting step, each of t replacement storage devices fetches one secondary data block from each of the d storage devices available to provide data for repair and decodes d blocks thus obtained, to recover d primary data blocks;
II. In an encoding step,
a) all t replacement storage devices encode the d primary blocks they recovered to produce a resulting secondary data block which is sent to each of the other t−1 replacement storage devices;
b) all d storage devices that are available to provide data for repair encode the d primary blocks they detain to produce t different resulting secondary data blocks which are sent to the t replacement storage devices, each of t replacement storage devices receiving one of the t different resulting secondary data blocks from a same of the d storage devices;
III. In a storage step, all t replacement storage devices store the secondary data blocks they received in the previous steps.

8. A device wherein said device is part of t replacement storage devices for exact repair of t failed storage devices interconnected in a distributed storage system, said device comprising:
a data collector for collecting data, where the replacement storage device fetches one secondary data block from each of d storage devices available to provide data for repair;
a decoder for decoding d blocks thus obtained, and to recover d primary data blocks;
an encoder for encoding the d primary data blocks recovered to produce a resulting secondary data block and a network interface to transmit this resulting secondary data block to each of the other t−1 replacement storage devices;
a receiver for receiving of resulting secondary data blocks that are transmitted by the d storage devices available for repair and by the t−1 other replacement devices;
storage for storing of the primary data blocks recovered and the secondary data blocks received.

9. The device according to claim 8, wherein said device is adapted to implement the method of claim 1.
